(19) United States
(12) Patent Application Publication
(10) Pub. No.: US 2022/0308593 A1
(43) Pub. Date: Sep. 29, 2022

(54) Transfer Apparatuses And Methods Thereof

(71) Applicants: Sintai Optical (Shenzhen) Co., Ltd., ShenZhen City (CN); Asia Optical Co., Inc., Taichung (TW)

(72) Inventors: Chien-Heng Yu, Taichung (TW); Chih-Hui Chen, Taichung (TW); Chuan-Kuei Lu, Taichung (TW); Chih-Hsuan Lee, Taichung (TW)

(21) Appl. No.: 17/683,441

(22) Filed: Mar. 1, 2022

(30) Foreign Application Priority Data
Mar. 26, 2021 (CN) 202110323703.8

(51) Int. Cl. G05D 1/02; G01S 17/89; G01S 17/931; G06T 7/579

(52) U.S. Cl. CPC G05D 1/0274; G05D 1/0225; G05D 1/027; G05D 1/024; G05D 1/0242; G05D 1/0255; G05D 1/0217; G05D 1/0236; G01S 17/89; G01S 17/931; G06T 7/579; G06T 2207/10028; G06T 2207/30252

(57) ABSTRACT

Transfer apparatuses and methods thereof are provided. First, a laser ranging unit is used to perform a first scanning ranging operation for an environment to obtain a laser scanning ranging result of the environment. Then, a displacement calculation unit is used to detect displacement information of a transfer apparatus. According to the laser scanning ranging result and the displacement information, map information of the environment is established and positioning information of the transfer apparatus in the environment is determined, wherein the map information includes information of a charging device. The map information and the positioning information of the transfer apparatus is transmitted to an application device via a connection interface. The connection interface is used to connect and fix the application device, and is electrically connected to the application device, wherein the transfer apparatus receives a charging operation instruction transmitted from the application device via the connection interface.

### BACKGROUND OF THE INVENTION

### Field of the Invention

The disclosure relates generally to transfer apparatuses and methods thereof, and, more particularly to a transfer platform that can focus on map construction and obstacle avoidance movement, thus to provide other application devices that can be connected to obtain map information and issue instructions to drive the transfer platform to move.

### Description of the Related Art

With the changes in the environment in recent years, such as the aging and declining birth rate, robots can be used as companions and solutions to fill the human gap, so robots have become a hot research topic in the industry. At the same time, with the development of automation and intelligence in the manufacturing industry, robots have become more and more intelligent and have greater flexibility.

At present, robotics technology has already made significant developments. For example, the technology of Simultaneous Localization And Mapping (SLAM) is becoming more mature for the environment map construction and device positioning. However, due to the high barriers to entry of related technologies, related service providers need to spend a lot of time and manpower to develop related technologies. This often results in delays in the time to market for related services.

On the other hand, in terms of environmental detection technology, there are currently different sensor solutions available in the industry, such as infrared sensors, laser sensors, and image sensors. Since different sensors have their advantages and disadvantages for different fields, considering the use and development of sensors and their technologies is also a barrier for entering this industry.

### BRIEF SUMMARY OF THE INVENTION

In an embodiment of a transfer method for use in a transfer apparatus. First, a laser ranging unit is used to perform a first scanning ranging operation for an environment to obtain a laser scanning ranging result of the environment. Then, a displacement calculation unit is used to detect displacement information of a transfer apparatus. According to the laser scanning ranging result and the displacement information, map information of the environment is established and positioning information of the transfer apparatus in the environment is determined, wherein the map information includes information of a charging device. The map information and the positioning information of the transfer apparatus is transmitted to an application device via a connection interface. The connection interface is used to connect and fix the application device, and is electrically connected to the application device, wherein the transfer apparatus receives a charging operation instruction transmitted from the application device via the connection interface.

An embodiment of a transfer apparatus comprises a laser ranging unit, an actuation module, a displacement calculation unit, a connection interface, and a processing unit. The laser ranging unit performs a first scanning ranging operation for an environment to obtain a laser scanning ranging result corresponding to the environment. The actuation module causes the transfer apparatus to move in the environment. The displacement calculation unit detects displacement information corresponding to the movement of the transfer apparatus. The connection interface connects and fixes an application device, and electrically connects with the application device. The processing unit establishes map information corresponding to the environment and determines positioning information of the transfer apparatus in the environment based on the laser scanning ranging result and the displacement information, wherein the map information comprises information of a charging device. The processing unit transmits the map information and the positioning information of the transfer apparatus to the application device via the connection interface, wherein the transfer apparatus receives a charging operation instruction transmitted from the application device via the connection interface.

In some embodiments, the transfer apparatus further comprises an inertial measurement unit and an ultrasonic sensor. The inertial measurement unit measures a state of the transfer apparatus. The ultrasonic sensor emits a plurality of ultrasonic waves to the environment to perform a second ranging operation to obtain an ultrasonic ranging result of the environment. The processing unit establishes the map information corresponding to the environment using a simultaneous localization and mapping technology according to the laser scanning ranging result, the state detected by the inertial measurement unit, and the ultrasonic ranging result, and adjusts the displacement information corresponding to the movement of the transfer apparatus according to the laser scanning ranging result or the ultrasonic ranging result.

In some embodiments, the transfer apparatus further comprises an inertial measurement unit and a 3D depth vision sensor. The inertial measurement unit measures a state of the transfer apparatus. The 3D depth vision sensor obtains a 3D depth ranging result corresponding to the environment. The processing unit adjusts the map information corresponding to the environment based on the 3D depth ranging result or the state detected by the inertial measurement unit, and adjusts the displacement information corresponding to the movement of the transfer apparatus according to the laser scanning ranging result, the state detected by the inertial measurement unit, or the 3D depth ranging result.

In some embodiments, the processing unit further receives a movement instruction from the application device via the connection interface, analyzes the movement instruction, and causes the transfer apparatus to move according to the movement instruction.

In some embodiments, the processing unit further performs an obstacle avoidance operation based on the map information and the positioning information of the transfer apparatus to prevent the transfer apparatus from colliding with at least one obstacle in the environment during the movement, and the application device further comprises a ranging unit for performing a second scanning ranging operation for the environment to obtain a second laser scanning ranging result corresponding to the environment, wherein the second laser scanning ranging result is transmitted to the transfer apparatus via the connection interface, and the map information of the environment is established and the positioning information of the transfer apparatus in the environment is determined according to the laser scanning ranging result, the second laser scanning ranging result, and the displacement information.

In some embodiments, the processing unit further provides the power of a battery of the transfer apparatus to the application device through the connection interface.

In some embodiments, the laser distance measurement unit further recognizes a specific reflective infrared mark corresponding to a first charging station in the first scanning ranging operation, records the specific reflective infrared mark in the map information, and the processing unit determines whether the first charging station is available to use according to whether the laser ranging unit detects the specific reflective infrared mark when the transfer apparatus performs a charging operation.

In some embodiments, the processing unit further transmits a transfer charging instruction to a specific transfer apparatus being charged at the first charging station, and in response to the transfer charging instruction, determines whether the remaining power of the specific transfer apparatus is sufficient for the specific transfer apparatus to move to a second charging station, and when the remaining power of the specific transfer apparatus is sufficient for the specific transfer apparatus to move to the second charging station, instructs the specific transfer apparatus to move to the second charging station for charging, and instructs the transfer apparatus to move to the first charging station for charging.

In some embodiments, the processing unit further instructs the transfer apparatus to enter a low power mode, and wait for the first charging station to be released by the specific transfer apparatus when the remaining power of the specific transfer apparatus is insufficient for the specific transfer apparatus to move to the second charging station, and instructs the transfer apparatus to move to the first charging station for charging after the first charging station is released by the specific transfer apparatus.

Transfer methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a transfer apparatus of the invention;

FIG. 2 is a schematic diagram illustrating an embodiment of a connection interface of the invention;

FIG. 3 is a schematic diagram illustrating an embodiment of an example of a transfer apparatus of the invention;

FIG. 4 is a schematic diagram illustrating an embodiment of an actuation module of the invention;

FIG. 5 is a schematic diagram illustrating another embodiment of a transfer apparatus of the invention;

FIG. 6 is a flowchart of an embodiment of a transfer method of the invention;

FIG. 7 is a schematic diagram illustrating an embodiment of an example of map information of the invention;

FIG. 8 is a flowchart of another embodiment of a transfer method of the invention;

FIG. 9 is a flowchart of another embodiment of a transfer method of the invention;

FIG. 10 is a flowchart of an embodiment of a charging management method for transfer apparatuses of the invention; and

FIG. 11 is a schematic diagram illustrating an embodiment of an example of connection between the transfer apparatus and the application device of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

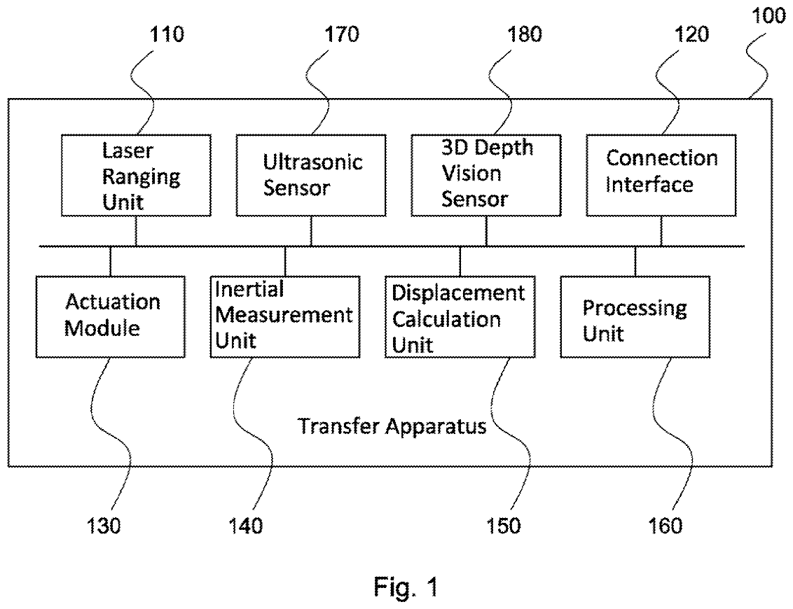

FIG. 1 illustrates an embodiment of a transfer apparatus of the invention. The transfer apparatus 100 according to the embodiment of the present invention comprises a laser ranging unit 110, a connection interface 120, an actuation module 130, an inertial measurement unit 140, a displacement calculation unit 150, an ultrasonic sensor 170, a three-dimensional (3D) depth vision sensor 180, and a processing unit 160 electrically coupled to the laser ranging unit 110, the ultrasonic sensor 170, the connection interface 120, the actuation module 130, the inertial measurement unit 140, and the displacement calculation unit 150.

The laser ranging unit 110 may comprise a transmitting module and a receiving module (not shown in the figure). The transmitting module can emit a measuring beam, and the measuring beam is reflected by a target in the environment to the receiving module. A distance measuring formula is used to calculate the distance between the ranging unit and the target according to the time of emitting laser light and the time of receiving reflected laser light. The scanning ranging information corresponding to the environment can be obtained by continuously scanning the environment.

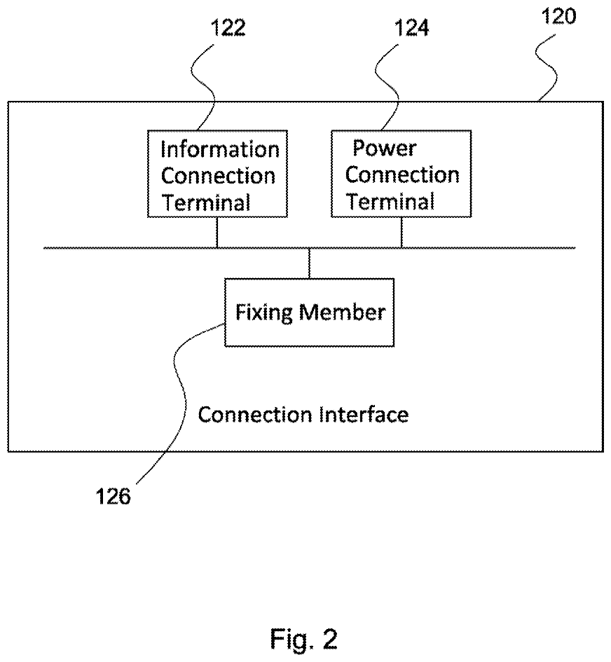

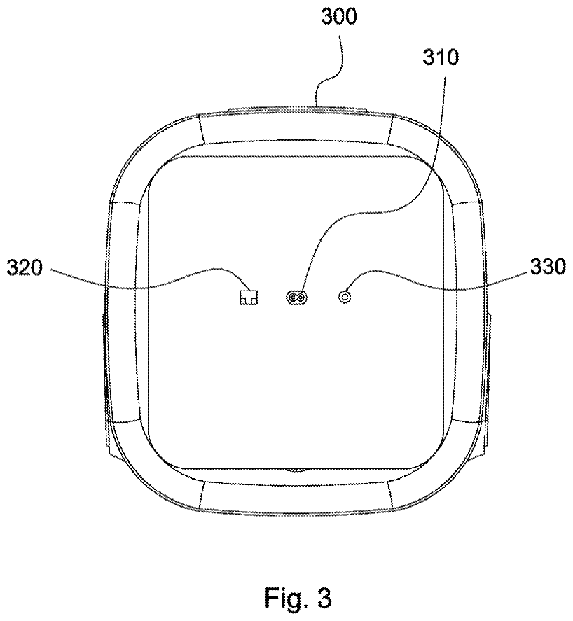

FIG. 2 illustrates an embodiment of a connection interface of the invention. The connection interface 120 according to the embodiment of the present invention comprises an information connection terminal 122, a power connection terminal 124, and a fixing member 126. In some embodiments, the information connection terminal 122 may be used to connect (for example, but not limited to) an RJ45 terminal of an Ethernet network. The fixing member 126 can connect and fix an application device. It is noted that, the application device has terminals corresponding to the information connection terminal 122 and the power connection terminal 124 for connection and communication. In some embodiments, the power connection terminal 124 may be an AC terminal and/or a DC terminal for supplying power from a battery (not shown in FIG. 1) in the transfer apparatus 100 to the application device. FIG. 3 shows an example of a transfer apparatus according to an embodiment of the present invention. In this example, the connection interface of the transfer apparatus 300 may include an information connection terminal 320, such as but not limited to an RJ45 terminal. The connection interface of the transfer apparatus 300 also includes an AC power connection terminal 310 and a DC power connection terminal 330.

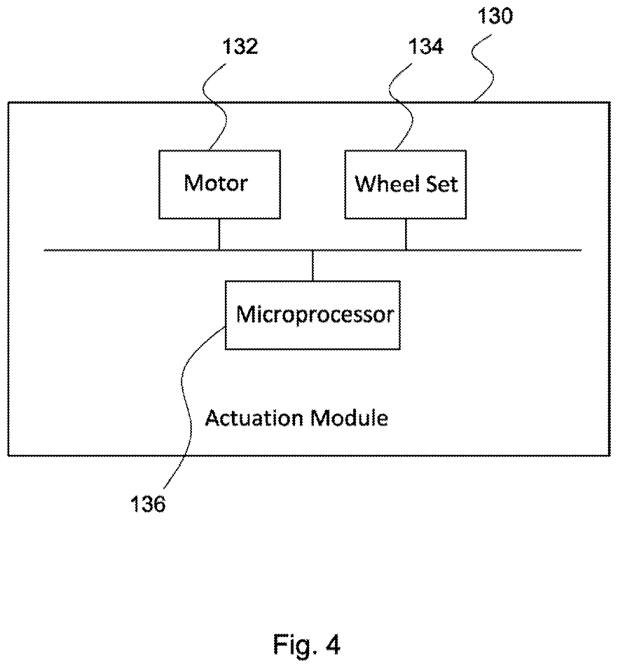

When the actuation module 130 is actuated, the transfer apparatus 100 can be moved accordingly. FIG. 4 shows an actuation module according to an embodiment of the invention. The actuation module 130 according to the embodiment of the present invention includes a motor 132, a wheel set 134, and a microprocessor 136. It is noted that, in some embodiments, the wheel set 134 may comprise a front wheel set and two sets of universal wheels at the rear. This wheel set design can provide the transfer apparatus 100 with better off-road obstacle avoidance performance and stability than a general two-wheel drive robot. It is noted that, the actuation module 130 in this case uses the wheel set as an example, but not as a limitation. Other appropriate actuation modules can be selected according to the respective environments. For example, the actuation module may have crawlers. It is noted that, the wheel-type and crawler-type actuation modules are only examples of the invention, and the present invention is not limited thereto.

The inertial measurement unit (IMU) 140 can measure the three-axis angular velocity and acceleration of the transfer apparatus 100 to obtain a corresponding state of the transfer apparatus 100. The displacement calculation unit 150 can detect the movement of the transfer apparatus 100 over time to generate corresponding displacement information. The ultrasonic sensor 170 can emit multiple ultrasonic waves to the environment to perform a ranging operation to obtain an ultrasonic ranging result of the corresponding environment. The 3D depth vision sensor 180 can be a depth camera, such as a Time of Flight (TOF) camera, dual camera stereo vision, or structured light projection stereo vision to detect the depth information of the environment and/or objects. In some embodiments, the 3D depth vision sensor 180 can obtain a 3D depth ranging result of a corresponding environment. It is understood that, in some embodiments, the 3D depth vision sensor 180 may utilize technologies such as Stereo Vision, Structured Light, and/or TOF technologies. It is noted that, the present invention is not limited to any one technology. The processing unit 160 can execute the transfer methods of the resent invention according to the output data of the laser ranging unit 110, the ultrasonic sensor 170, the 3D depth vision sensor 180, the inertial measurement unit 140, and the displacement calculation unit 150. The details will be described later.

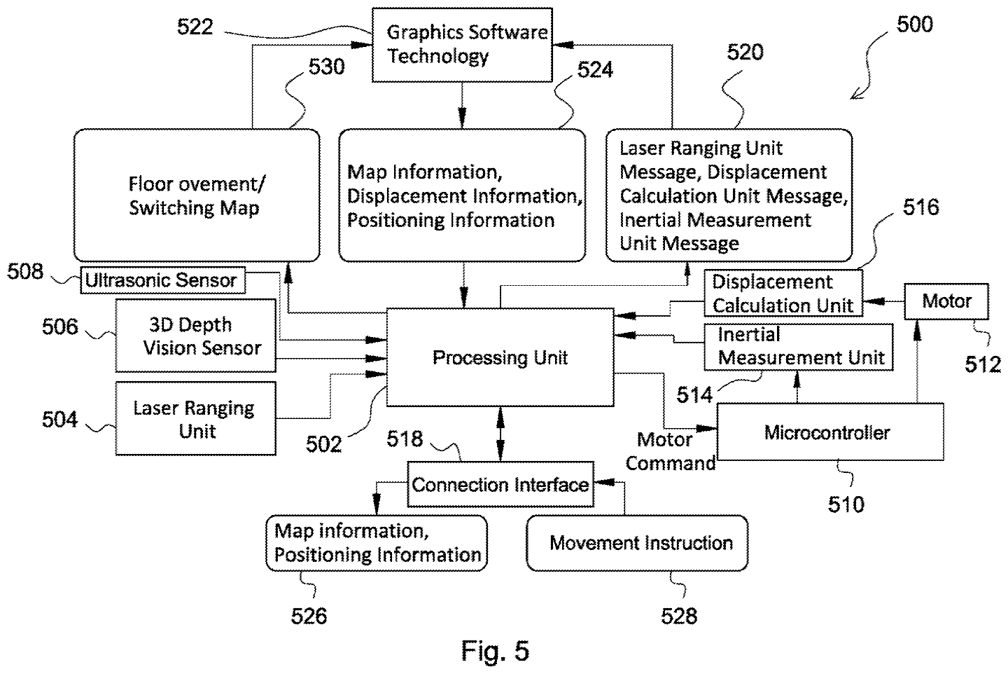

FIG. 5 is a schematic diagram illustrating another embodiment of a transfer apparatus of the invention. The transfer apparatus 500 according to the embodiment of the present invention comprises a processing unit 502, a laser ranging unit 504, a 3D depth vision sensor 506, an ultrasonic sensor 508, a microcontroller 510 for controlling a motor 512 and an inertial measurement unit 514, a displacement calculation unit 516, and a connection interface 518. It is noted that, in some embodiments, the 3D depth vision sensor 506 and the ultrasonic sensor 508 can be selectively configured. The processing unit 502 can receive the data detected by the laser ranging unit 504. When the 3D depth vision sensor 506 and the ultrasonic sensor 508 are selected to configure, the processing unit 502 can also receive the data detected by the 3D depth vision sensor 506 and the ultrasonic sensor 508. On the other hand, the processing unit 502 can output a motor command to the microcontroller 510 to control the action of the motor 512. It is reminded that, the motor 512 can be part of the actuation module to drive the transfer apparatus 500 to move. When the transfer apparatus 500 moves, the displacement calculation unit 516 and the inertial measurement unit 514 can perform detection and calculation, and send the generated data to the processing unit 502. The processing unit 502 can use a graphics software technology 522, such as Cartographer to obtain map information of the environment, and displacement information and positioning information 524 of the transfer apparatus according to the data detected by the laser ranging unit 504, the displacement calculation unit 516, and the inertial measurement unit 514, such as the laser ranging unit message, displacement calculation unit message, and inertial measurement unit message 520. The processing unit 502 can transmit the map information and the positioning information 526 to an application device via the connection interface 518 using a customized communication format. The application device can perform related applications and judgments based on the received data, and send a movement instruction 528 to the processing unit 502 via the connection interface 518. The processing unit 502 can perform subsequent operations according to the movement instruction 528. It is reminded that, if the environment has multiple floors, each floor can have corresponding map information. When receiving a request for floor change or floor movement, the processing unit 502 can perform operations of floor movement/switching map 530, and establish the map information of the corresponding floor based on the data output by the laser ranging unit 504, 3D depth vision sensor 506, and/or ultrasonic sensor 508.

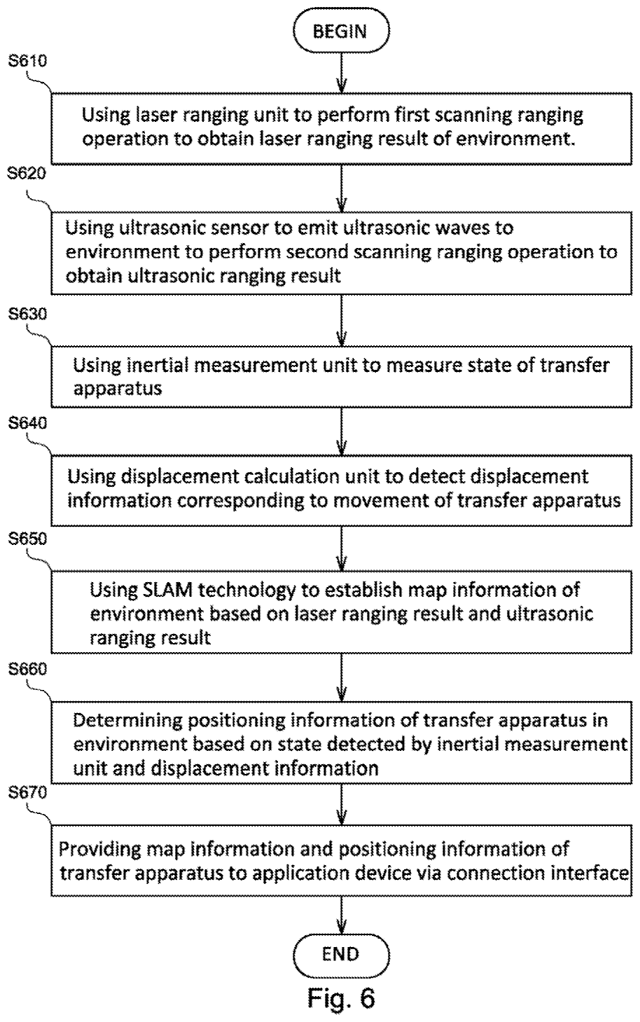

FIG. 6 shows a transfer method according to an embodiment of the invention. The transfer method according to the embodiment of the present invention is suitable for the transfer apparatus as shown in FIG. 1. In this embodiment, the transfer apparatus can establish map information of an environment based on the laser ranging result, and provide related information to the connected application device.

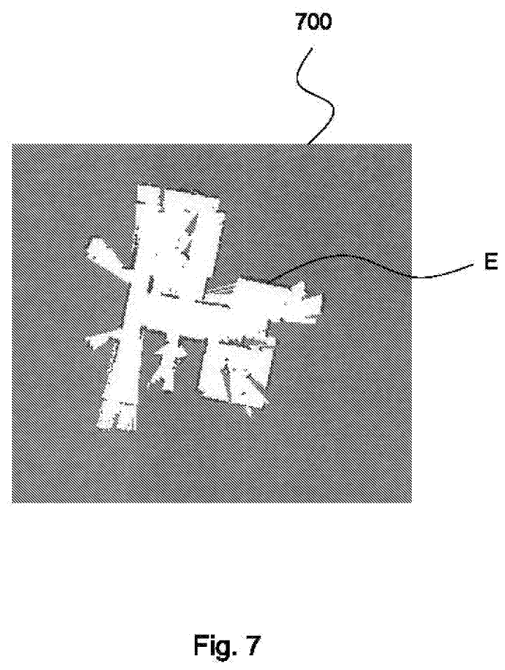

In step S610, a laser ranging unit is used to emit a plurality of laser lights to an environment to perform a first scanning ranging operation to obtain a laser ranging result of the environment. As mentioned above, the transmitting module of the laser ranging unit can emit a measuring beam, and the measuring beam is reflected by a target to the receiving module. A distance-measuring formula can be used to calculate the distance between the ranging device and the target according to the time when the laser light is emitted and the time when the reflected laser light is received. In step S620, an ultrasonic sensor of the transfer apparatus is used to emit a plurality of ultrasonic waves to the environment to perform a second scanning ranging operation to obtain an ultrasonic ranging result of the environment. As mentioned above, the ultrasonic sensor can emit ultrasonic waves in a certain direction to propagate in the air. The sensor starts timing when the ultrasonic waves are emitted. If the ultrasonic wave hits an obstacle, the ultrasonic wave will be reflected back to the ultrasonic sensor, and the timing will stop at this time. Since the propagation speed of the ultrasonic wave in the air is known, the distance between the launch point and the obstacle can be calculated according to the time it takes for the ultrasonic wave to go back and forth. In step S630, an inertial measurement unit is used to measure a state of the transfer apparatus, and in step S640, a displacement calculation unit is used to detect displacement information corresponding to the movement of the transfer apparatus. It is reminded that, in some embodiments, the operations of steps S610, S620, S630, and S640 may be continuously performed during the movement of the transfer apparatus. Then, in step S650, a Simultaneous Localization And Mapping (SLAM) technology is used to establish map information of the environment based on the laser ranging result and the ultrasonic ranging result, such as the example of map information in FIG. 7. The map information 700 can record the environmental boundary E detected by the laser ranging. It is understood that, in some embodiments, the map information can be created using a graphics software technology (such as but not limited to Cartographer). It should be reminded that the Cartographer technology is only an example of creating the map in this case, and the present invention is not limited thereto. It is understood that, in some embodiments, when the mobile device has a 3D depth vision sensor, the 3D depth vision sensor can be used to obtain a 3D depth ranging result of the environment, and the map information of the environment can be adjusted according to the 3D depth ranging result. It is noted that, in some embodiments, the 3D depth vision sensor may utilize technologies such as Stereo Vision, Structured Light, and/or Time of Flight (TOF) to implement, and the present invention is not limited to any one technology. Then, in step S660, positioning information of the transfer apparatus in the environment is determined based on the state detected by the inertial measurement unit and the displacement information detected by the displacement calculation unit, wherein the laser ranging result, the ultrasonic ranging, and/or the 3D depth ranging result can be coordinated to correct the displacement calculation unit to detect the displacement information corresponding to the movement of the transfer apparatus, so that the positioning information can be more accurate. Finally, in step S670, the map information and the positioning information of the transfer apparatus are provided to an application device via a connection interface. It is reminded that, the connection interface is used to connect and fix the application device and communicate with the application device. It is noted that, in some embodiments, the power of a battery of the transfer apparatus can be provided to the application device through the connection interface.

It must be noted that, in the embodiment of FIG. 6, a laser ranging unit, an ultrasonic sensor, an inertial measurement unit, and a displacement calculation unit are used for detection in a specific order. However, in some embodiments, the order of using the aforementioned components can be determined according to different applications or requirements, or can be used at the same time to perform related detection operations, and the present invention is not limited to any order of use.

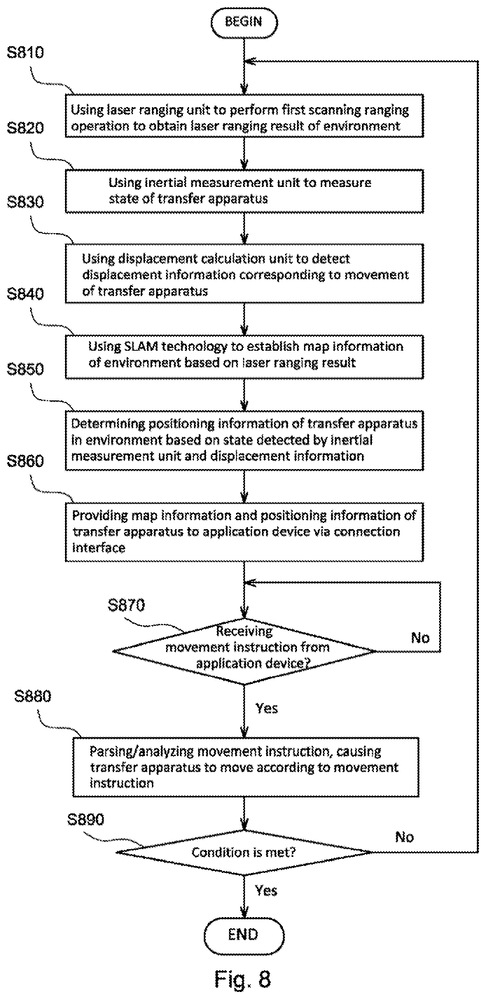

FIG. 8 shows a transfer method according to another embodiment of the invention. The transfer method according to the embodiment of the present invention is suitable for the transfer apparatus as shown in FIG. 1. In this embodiment, the transfer apparatus can establish map information of an environment based on the laser ranging result, and provide related information to the connected application device. The transfer apparatus can further receive user's instruction from the application device, thus to cause the transfer apparatus to move in response to the instruction transmitted by the application device via the connection interface.

In step S810, a laser ranging unit is used to emit a plurality of laser lights to an environment to perform a first scanning ranging operation to obtain a laser ranging result of the environment. As mentioned above, the transmitting module of the laser ranging unit can emit a measuring beam, and the measuring beam is reflected by a target to the receiving module. A distance-measuring formula can be used to calculate the distance between the ranging device and the target according to the time when the laser light is emitted and the time when the reflected laser light is received. In step S820, an inertial measurement unit is used to measure a state of the transfer apparatus, and in step S830, a displacement calculation unit is used to detect displacement information corresponding to the movement of the transfer apparatus. It is reminded that, in some embodiments, the operations of steps S810, S820, and S830 may be continuously performed during the movement of the transfer apparatus. Similarly, in the embodiment of FIG. 8, a laser ranging unit, an inertial measurement unit, and a displacement calculation unit are used for detection in a specific order. However, in some embodiments, the order of using the aforementioned components can be determined according to different applications or requirements, or can be used at the same time to perform related detection operations, and the present invention is not limited to any order of use. Then, in step S840, a SLAM technology is used to establish map information of the environment based on the laser ranging result. Similarly, in some embodiments, the map information can be created using the Cartographer technology. It should be reminded that the Cartographer technology is only an example of creating the map in this case, and the present invention is not limited thereto. Then, in step S850, positioning information of the transfer apparatus in the environment is determined based on the state detected by the inertial measurement unit and the displacement information detected by the displacement calculation unit, wherein the laser ranging result can be coordinated to correct the displacement calculation unit to detect the displacement information corresponding to the movement of the transfer apparatus, so that the positioning information can be more accurate. In step S860, the map information and the positioning information of the transfer apparatus are provided to an application device via a connection interface. It is reminded that, the connection interface is used to connect and fix the application device and communicate with the application device. It is noted that, in some embodiments, the power of a battery of the transfer apparatus can be provided to the application device through the connection interface. Then, in step S870, the transfer apparatus determines whether a movement instruction is received from the application device. When the moving instruction is not received (No in step S870), the determination in step S870 is continued. When the movement instruction is received from the application device (Yes in step S870), in step S880, the movement instruction is parsed/analyzed, and the transfer apparatus is caused to move according to the movement instruction. In step S890, the step loop in FIG. 8 may be terminated due to the user's request to terminate or other factors (such as encountering obstacles, etc.). If the user's request or the factors occur, the condition in step S890 is met, and the procedure ends. At this time, a call for help may be issued to the user. In addition, it can be understood that, the order of the steps shown in FIG. 8 can be adjusted according to different situations, and the present invention is not limited to any order of use.

It is understood that, in some embodiments, in the first scanning ranging operation, the laser ranging unit will detect obstacles in the environment and display them in the map information. In some embodiments, when the transfer apparatus is moved according to the movement instruction, an obstacle avoidance operation can be performed based on the map information and the positioning information of the transfer apparatus to prevent the transfer apparatus from colliding with at least one obstacle in the environment during the movement. It is understood that, the first scanning ranging operation is performed by the transfer apparatus. When the application device is loaded on the transfer apparatus through the connection interface, the overall height will be in short, the overall height of the transfer apparatus equipped with the application device will be higher than the height of only the transfer apparatus. At this time, the movement may be unreliable if only the laser scanning ranging result of the first scanning ranging operation is used. That is, the application device will not collide according to the first scanning ranging operation, but after the application device is mounted, the overall height of the transfer apparatus equipped with the application device may not be able to avoid obstacles completely if the height range from the result does not reach the overall height of the transfer apparatus equipped with the application device. Therefore, the application device can be also configured with a second ranging unit to perform a second scanning ranging operation for the environment to obtain a second scanning ranging result corresponding to the environment, and the second scanning ranging result can also be provided to the transfer apparatus as the data for creating the map information. The second ranging unit may be, for example, but not limited to, an ultrasonic sensor unit, a laser distance measurement unit, an image sensor unit, a 3D depth vision sensor 180, a far-infrared ranging unit, and others.

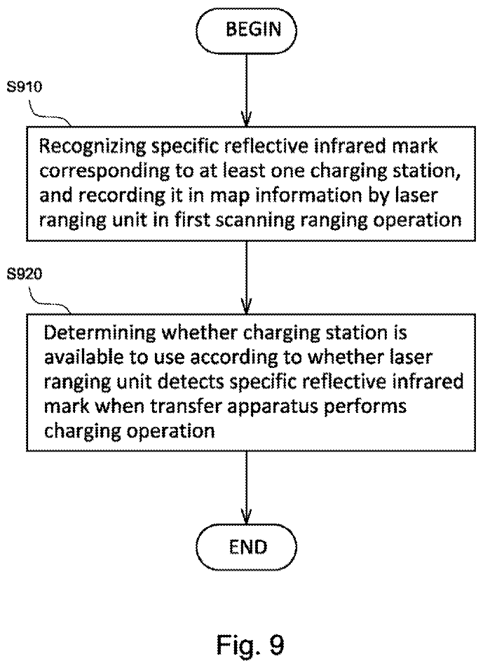

FIG. 9 shows a transfer method according to another embodiment of the invention. In this embodiment, the laser ranging unit will detect charging stations in the environment, and the charging station information will be marked in the map information.

In step S910, in the first scanning ranging operation, the laser ranging unit recognizes a specific reflective infrared mark corresponding to at least one charging station, and records it in the map information. Then, in step S920, when the transfer apparatus performs a charging operation, it is determined whether the charging station is available to use according to whether the laser ranging unit detects a specific reflective infrared mark. It is reminded that, when the laser ranging unit cannot detect the specific reflected infrared mark of a charging station, it means that the charging station is being used by other transfer apparatus.

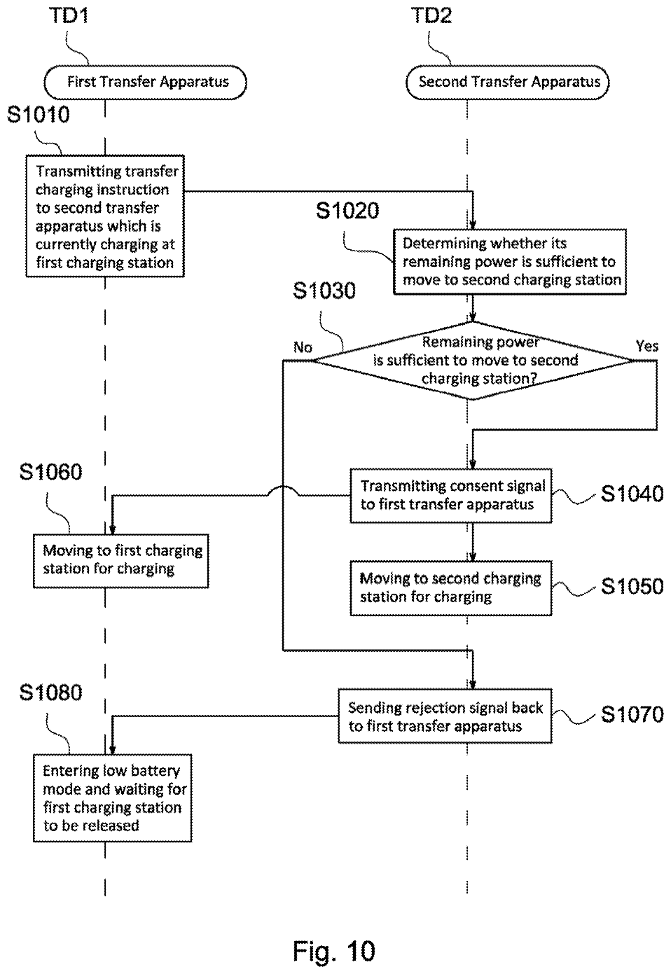

FIG. 10 shows a charging management method between transfer apparatuses according to an embodiment of the present invention. In this embodiment, there are a first charging station and a second charging station in the environment, and the transfer apparatuses (the first transfer apparatus TD1 and the second transfer apparatus TD2) will communicate with each other to coordinate charging.

When the power of the transfer apparatus TD1 is insufficient to reach the second charging station in the environment, and the second transfer apparatus TD2 is currently charging at the first charging station, in step S1010, the first transfer apparatus TD1 transmits a transfer charging instruction to the second transfer apparatus TD2 which is currently charging at the first charging station. In response to the transfer charging instruction, in step S1020, the second transfer apparatus TD2 determines whether its remaining power is sufficient to move to the second charging station. It is noted that, in some embodiments, the second transfer apparatus TD2 may first determine whether the second charging station is currently available, and when the second charging station is currently available, the determination in step S1020 is performed. When the second charging station is currently unavailable, a rejection signal will be sent back to the first transfer apparatus TD1. When the remaining power of the second transfer apparatus TD2 is sufficient to move to the second charging station (Yes in step S1030), in step S1040, the second transfer apparatus TD2 transmits a consent signal to the first transfer apparatus TD1, and in step S1050, the second transfer apparatus TD2 moves to the second charging station for charging. In response to the consent signal, in step S1060, the first transfer apparatus TD1 moves to the first charging station for charging. When the remaining power of the second transfer apparatus TD2 is insufficient to move to the second charging station (No in step S1030), in step S1070, the second transfer apparatus TD2 sends a rejection signal back to the first transfer apparatus TD1. In response to the rejection signal, in step S1080, the first transfer apparatus TD1 enters a low battery mode and waits for the first charging station to be released by the second transfer apparatus TD2. The first transfer apparatus TD1 can move to the first charging station for charging after the first charging station is released by the second transfer apparatus TD2. It is reminded that, when the remaining power of the first transfer apparatus TD1 and the second transfer apparatus TD2 cannot be moved to the second charging station, the first transfer apparatus TD1 will enter the low power mode.

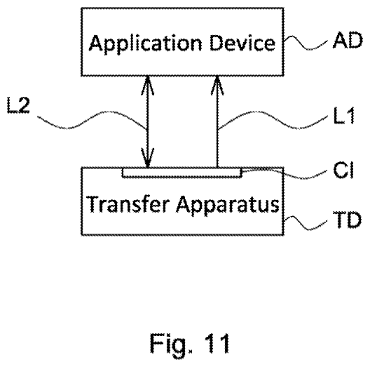

FIG. 11 shows an example of connection between a transfer apparatus and an application device according to an embodiment of the present invention. As shown in FIG. 11, a transfer apparatus TD can be connected to an application device AD through a connection interface CI. The application device AD can obtain the power required for operation from the transfer apparatus TD through a power connection L1 through its power connection port (not shown in the figure). At the same time, the application device AD can obtain the map information and the positioning information from the transfer apparatus TD through an information link L2 through its information port (not shown in the figure), and send a movement instruction to the transfer apparatus TD through the information link L2. The transfer apparatus TD can move in response to the movement instruction.

Therefore, the transfer apparatuses and methods of the present invention can focus on the transfer platform for map construction and obstacle avoidance movement, so as to provide other application devices that can be connected to obtain map information and issue instructions to drive the transfer platform to move. In the present invention, the ultrasonic distance and positioning status can be also used to construct the map information, and the laser ranging results can be also used to complete the map information, thus to avoid the blind angle of laser ranging, and solve the disadvantage that the laser ranging technology cannot recognize the transparent glasses. With this case, the various industries do not need to spend resources to develop complex positioning technology and movement control. In this case, a universal transfer module is created to carry the upper-level products through a specific communication interface. The application device can issue instructions to the transfer platform of the present invention and obtain related status. The various industries can quickly produce transfer and positioning robot products.

Transfer methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A transfer method for use in a transfer apparatus, comprising:
performing a first scanning ranging operation for an environment by using a laser ranging unit of the transfer apparatus, to obtain a laser scanning ranging result of the environment;
detecting displacement information of the transfer apparatus by using a displacement calculation unit of the transfer apparatus;
establishing map information of the environment, and determining positioning information of the transfer apparatus in the environment according to the laser scanning ranging result and the displacement information, wherein the map information comprises information of a charging device; and
transmitting the map information and the positioning information of the transfer apparatus to an application device via a connection interface, wherein the connection interface is used to connect and fix the application device, and is electrically connected to the application device, in which the transfer apparatus receives a charging operation instruction transmitted from the application device via the connection interface.

2. The transfer method of claim 1, further comprising:
measuring a state of the transfer apparatus by using an inertial measurement unit of the transfer apparatus;
emitting a plurality of ultrasonic waves to the environment to perform a second ranging operation by using an ultrasonic sensor of the transfer apparatus, to obtain an ultrasonic ranging result of the environment;
establishing the map information corresponding to the environment using a simultaneous localization and mapping technology according to the laser scanning ranging result, the state detected by the inertial measurement unit, and the ultrasonic ranging result; and
adjusting the displacement information corresponding to the movement of the transfer apparatus according to the laser scanning ranging result or the ultrasonic ranging result.

3. The transfer method of claim 1, further comprising:
measuring a state of the transfer apparatus by using an inertial measurement unit of the transfer apparatus;
obtaining a 3D depth ranging result corresponding to the environment by using a 3D depth vision sensor of the transfer apparatus;
adjusting the map information corresponding to the environment based on the 3D depth ranging result or the state detected by the inertial measurement unit; and
adjusting the displacement information corresponding to the movement of the transfer apparatus according to the laser scanning ranging result, the state detected by the inertial measurement unit, or the 3D depth ranging result.

4. The transfer method of claim 1, further comprising:
receiving a movement instruction from the application device via the connection interface; and
analyzing the movement instruction, and causing the transfer apparatus to move according to the movement instruction.

5. The transfer method of claim 4, further comprising:
performing an obstacle avoidance operation based on the map information and the positioning information of the transfer apparatus to prevent the transfer apparatus from colliding with at least one obstacle in the environment during the movement; and
performing a second scanning ranging operation for the environment to obtain a second laser scanning ranging result corresponding to the environment by using a ranging unit of the application device, wherein the second laser scanning ranging result is transmitted to the transfer apparatus via the connection interface, and the map information of the environment is established and the positioning information of the transfer apparatus in the environment is determined according to the laser scanning ranging result, the second laser scanning ranging result, and the displacement information.

6. The transfer method of claim 1, further comprising providing the power of a battery of the transfer apparatus to the application device through the connection interface.

7. The transfer method of claim 1, further comprising:
recognizing a specific reflective infrared mark corresponding to a first charging station in the first scanning ranging operation by using the laser distance measurement unit, and recording the specific reflective infrared mark in the map information; and
determining whether the first charging station is available to use according to whether the laser ranging unit detects the specific reflective infrared mark when the transfer apparatus performs a charging operation.

8. The transfer method of claim 7, further comprising:
transmitting a transfer charging instruction to a specific transfer apparatus being charged at the first charging station;
in response to the transfer charging instruction, determining whether the remaining power of the specific transfer apparatus is sufficient for the specific transfer apparatus to move to a second charging station; and
when the remaining power of the specific transfer apparatus is sufficient for the specific transfer apparatus to move to the second charging station, instructing the specific transfer apparatus to move to the second charging station for charging, and instructing the transfer apparatus to move to the first charging station for charging.

9. The transfer method of claim 8, further comprising:
instructing the transfer apparatus to enter a low power mode, and waits for the first charging station to be released by the specific transfer apparatus when the remaining power of the specific transfer apparatus is insufficient for the specific transfer apparatus to move to the second charging station; and
instructing the transfer apparatus to move to the first charging station for charging after the first charging station is released by the specific transfer apparatus.

10. A transfer apparatus, comprising:
a laser ranging unit performing a first scanning ranging operation for an environment to obtain a laser scanning ranging result corresponding to the environment;
an actuation module causing the transfer apparatus to move in the environment;
a displacement calculation unit detecting displacement information corresponding to the movement of the transfer apparatus;
a connection interface connecting and fixing an application device, and electrically connecting with the application device; and
a processing unit establishing map information corresponding to the environment and determining positioning information of the transfer apparatus in the environment based on the laser scanning ranging result and the displacement information, wherein the map information comprises information of a charging device, and transmitting the map information and the positioning information of the transfer apparatus to the application device via the connection interface, wherein the transfer apparatus receives a charging operation instruction transmitted from the application device via the connection interface.

11. The transfer apparatus of claim 10, further comprising:
an inertial measurement unit measuring a state of the transfer apparatus;
an ultrasonic sensor emitting a plurality of ultrasonic waves to the environment to perform a second ranging operation to obtain an ultrasonic ranging result of the environment; and
the processing unit establishing the map information corresponding to the environment using a simultaneous localization and mapping technology according to the laser scanning ranging result, the state detected by the inertial measurement unit, and the ultrasonic ranging result, and adjusting the displacement information corresponding to the movement of the transfer apparatus according to the laser scanning ranging result or the ultrasonic ranging result.

12. The transfer apparatus of claim 10, further comprising:
an inertial measurement unit measuring a state of the transfer apparatus;
a 3D depth vision sensor obtaining a 3D depth ranging result corresponding to the environment; and
the processing unit adjusting the map information corresponding to the environment based on the 3D depth ranging result or the state detected by the inertial measurement unit, and adjusting the displacement information corresponding to the movement of the transfer apparatus according to the laser scanning ranging result, the state detected by the inertial measurement unit, or the 3D depth ranging result.

13. The transfer apparatus of claim 10, wherein the processing unit further receives a movement instruction from the application device via the connection interface, analyzes the movement instruction, and causes the transfer apparatus to move according to the movement instruction.

14. The transfer apparatus of claim 13, wherein the processing unit further performs an obstacle avoidance operation based on the map information and the positioning information of the transfer apparatus to prevent the transfer apparatus from colliding with at least one obstacle in the environment during the movement, and the application device further comprises a ranging unit for performing a second scanning ranging operation for the environment to obtain a second laser scanning ranging result corresponding to the environment, wherein the second laser scanning ranging result is transmitted to the transfer apparatus via the connection interface, and the map information of the environment is established and the positioning information of the transfer apparatus in the environment is determined according to the laser scanning ranging result, the second laser scanning ranging result, and the displacement information.

15. The transfer apparatus of claim 10, wherein the processing unit further provides the power of a battery of the transfer apparatus to the application device through the connection interface.

16. The transfer apparatus of claim 10, wherein the laser distance measurement unit further recognizes a specific reflective infrared mark corresponding to a first charging station in the first scanning ranging operation, records the specific reflective infrared mark in the map information, and the processing unit determines whether the first charging station is available to use according to whether the laser ranging unit detects the specific reflective infrared mark when the transfer apparatus performs a charging operation.

17. The transfer apparatus of claim 16, wherein the processing unit further transmits a transfer charging instruction to a specific transfer apparatus being charged at the first charging station, and in response to the transfer charging instruction, determines whether the remaining power of the specific transfer apparatus is sufficient for the specific transfer apparatus to move to a second charging station, and when the remaining power of the specific transfer apparatus is sufficient for the specific transfer apparatus to move to the second charging station, instructs the specific transfer apparatus to move to the second charging station for charging, and instructs the transfer apparatus to move to the first charging station for charging.

18. The transfer apparatus of claim 17, wherein the processing unit further instructs the transfer apparatus to enter a low power mode, and wait for the first charging station to be released by the specific transfer apparatus when the remaining power of the specific transfer apparatus is insufficient for the specific transfer apparatus to move to the second charging station, and instructs the transfer apparatus to move to the first charging station for charging after the first charging station is released by the specific transfer apparatus.

19. A machine-readable storage medium comprising a computer program, which, when executed, causes a device to perform a transfer method for use in a transfer apparatus, wherein the method comprises:
performing a first scanning ranging operation for an environment by using a laser ranging unit of the transfer apparatus, to obtain a laser scanning ranging result of the environment;
detecting displacement information of the transfer apparatus by using a displacement calculation unit of the transfer apparatus;
establishing map information of the environment, and determining positioning information of the transfer apparatus in the environment according to the laser scanning ranging result and the displacement information, wherein the map information comprises information of a charging device; and
transmitting the map information and the positioning information of the transfer apparatus to an application device via a connection interface, wherein the connection interface is used to connect and fix the application device, and is electrically connected to the application device, in which the transfer apparatus receives a charging operation instruction transmitted from the application device via the connection interface.
